(19) United States
(12) Patent Application Publication
(10) Pub. No.: US 2017/0101929 A1
(43) Pub. Date: Apr. 13, 2017

(54) ENGINE CONFIGURATION HAVING VARIOUS DISPLACEMENTS

(71) Applicant: Cummins Inc., Columbus, IN (US)

(72) Inventor: John Peter Jones, Windermere, FL (US)

(73) Assignee: Cummins Inc., Columbus, IN (US)

(21) Appl. No.: 15/314,305

(22) PCT Filed: Jun. 25, 2015
(86) PCT No.: PCT/US2015/037696

§ 371 Date: Nov. 28, 2016

Related U.S. Application Data
(60) Provisional application No. 62/017,496, filed on Jun. 26, 2014.

(51) Int. Cl. F02B 75/04; F01L 3/08; F01L 3/10; F02F 1/24

(52) U.S. Cl. CPC F02B 75/047; F02F 1/24; F01L 3/08; F01L 3/10

(57) ABSTRACT

Various embodiments provide a method of varying engine displacement. The method includes determining a change in a stroke distance of the engine required to obtain a pre-determined volumetric change in a displacement of the engine. The method includes machining a top surface of a crankcase so as to remove a height of material from the crankcase. The height is calculated to correspond to the change in the stroke of the engine required to obtain the volumetric change in the displacement of the engine. The method also includes coupling the crankcase to an engine block portion of the engine.

### CROSS-REFERENCE TO RELATED PATENT APPLICATIONS

This application claims priority and the benefit of U.S. Provisional Patent Application No. 62/017,496, entitled “ENGINE CONFIGURATION HAVING VARIOUS DISPLACEMENTS,” filed on Jun. 26, 2014, the entire disclosure of which is incorporated herein by reference.

### TECHNICAL FIELD

The present disclosure relates to systems and methods for the manufacture of engines.

### BACKGROUND

Engine manufacturing is a complex and expensive process in view of the number of parts involved and the precision required to manufacture an engine block, particularly in substantial quantities. For example, an engine block for an engine may be manufactured by a casting process. In order to produce the block in significant quantities, casting molds may be created and manufacturing equipment may be configured to process the casting molds through the casting process. Accordingly, changing the displacement of an engine associated with the engine block generally requires re-designing or modifying a significant number of parts and may also require production of new molds as well as reconfiguration of complex manufacturing equipment configured to process the molds.

### SUMMARY

Various embodiments provide methods of varying engine displacement and internal combustion engine assemblies configured to permit such varying displacement.

In particular embodiments, a method of varying a displacement of an engine is provided that includes determining a change in a stroke distance of the engine required to obtain a pre-determined volumetric change in a displacement of the engine. The method includes machining a top surface of a crankcase so as to remove a height of material from the crankcase. The height is calculated to correspond to the change in the stroke of the engine required to obtain the volumetric change in the displacement of the engine. The method also includes coupling the crankcase to an engine block portion of the engine.

In particular embodiments, the engine block portion is integrally formed with a cylinder head portion. The method includes coupling a valve cartridge assembly to the cylinder head portion of the engine block portion, in accordance with particular embodiments. The valve cartridge assembly includes a cartridge housing including a port and a valve seat defining a valve seat opening. A valve is coupled to the cartridge housing and positioned, in part in the cartridge housing. The valve includes a valve stem and a valve head. The valve head is positioned in the valve seat of the cartridge housing in a closed configuration and the valve head extends out of the valve seat opening in an open configuration. The valve cartridge assembly includes a valve spring coupled to the cartridge housing and the valve stem of the valve, biasing the valve towards the closed configuration. In particular embodiments, coupling the valve cartridge assembly to the cylinder head portion includes inserting the valve cartridge assembly into a cartridge slot at the head portion through a cylinder opening of the engine block portion.

In particular embodiments, a valve cartridge assembly is provided that includes a cartridge housing including a port and a valve seat defining a valve seat opening. A valve is coupled to the cartridge housing and positioned, in part in the cartridge housing. The valve includes a valve stem and a valve head. The valve head is positioned in the valve seat of the cartridge housing in a closed configuration and the valve head extends out of the valve seat opening in an open configuration. The valve cartridge assembly includes a valve spring coupled to the cartridge housing and the valve stem of the valve, biasing the valve towards the closed configuration. The valve cartridge assembly may include a spring retainer coupling the valve spring to the valve stem. The cartridge housing fluidly couples the valve seat opening to the port, in accordance with particular embodiments.

In particular embodiments, an engine assembly is provided that includes an engine block including an engine block portion integrally formed with a cylinder head portion. The engine block portion includes a plurality of cylindrical cylinder block openings and a first mating surface. The engine assembly includes a crankcase coupled to the engine block portion. The crankcase may include a second mating surface comprising a crankcase extension, the crankcase extension configured for removal from the crankcase to change a displacement of the engine assembly. In particular embodiments, a valve cartridge assembly is coupled to the cylinder head portion of the engine block. The valve cartridge assembly includes a cartridge housing including a port and a valve seat defining a valve seat opening. A valve is disposed in the cartridge housing, the valve including a valve stem and a valve head, the valve head. The valve head is positioned in the valve seat in a closed configuration and the valve head extends out of the valve seat opening in an open configuration. The valve cartridge assembly includes a valve spring coupled to the cartridge housing and the valve stem of the valve, biasing the valve towards the closed configuration.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

The skilled artisan will understand that the drawings primarily are for illustrative purposes and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

FIG. 1 is a perspective view of an engine assembly configured for varied engine displacement, in accordance with example embodiments.

FIG. 2 is a side cross-sectional view of an engine assembly configured for varied engine displacement, in accordance with example embodiments.

FIG. 3 is a flow diagram showing a method of varying engine displacement, in accordance with example embodiments.

FIG. 4 is a side view of a cartridge assembly for use with an engine assembly, in accordance with example embodiments.

FIG. 5 is a side cross-sectional view of the cartridge assembly of FIG. 4.

FIG. 6 is a cross-sectional view of an engine assembly including the cartridge assembly of FIG. 4, in accordance with example embodiments.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, varying engine displacement and various internal combustion engine components. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

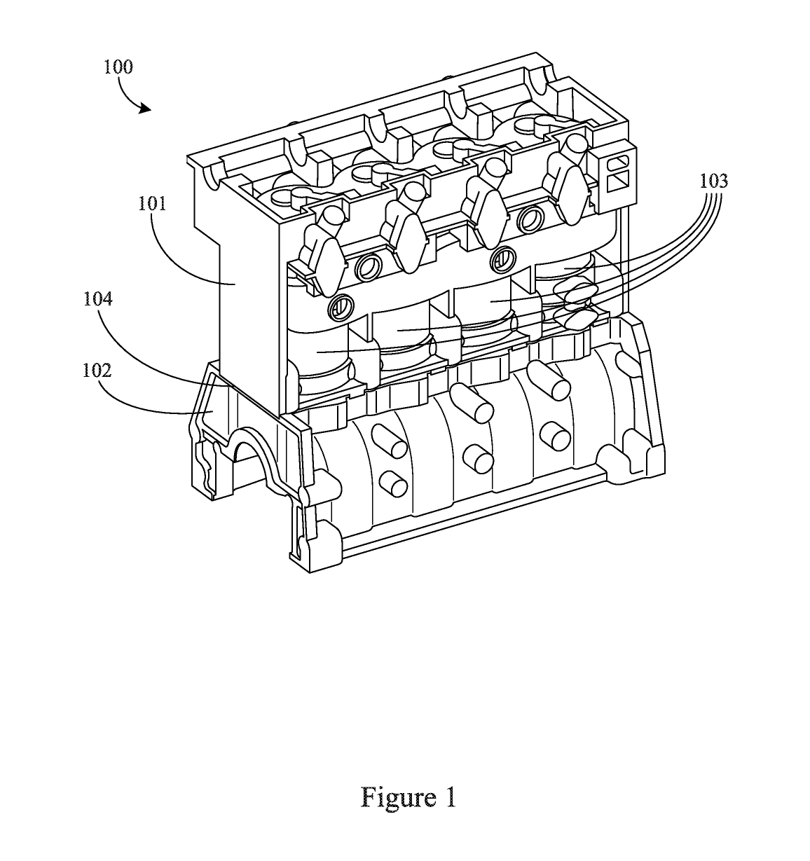

FIG. 1 is a perspective view of an engine assembly configured for varied engine displacement, in accordance with example embodiments. An engine assembly 100 includes a combined cylinder head and cylinder block portion 101 and a crankcase portion 102. The combined cylinder head and cylinder block portion 101 includes an engine block portion integrally formed with a cylinder head portion. The engine block portion houses a plurality of cylinders 103, each cylinder defining a cylindrical bore housing an oscillating piston. Each piston is communicatively engaged to a rotating crankshaft via a rod, such that the rotation of the crankshaft drives the oscillation of the piston.

The cylinder head portion is configured to house a plurality of intake and exhaust valves, and to couple those valves to an intake manifold and an exhaust manifold, respectively. Being of a single monolithic construction, the combined cylinder head and cylinder block portion 101 eliminates the need for a head gasket (i.e., that may otherwise be needed at a block-head junction), thereby permitting higher peak cylinder pressures. The combined cylinder head and cylinder block portion 101 may be manufactured by casting, in accordance with example embodiments. In particular embodiments, the combined cylinder head and cylinder block portion 101 may be composed, in part, or in whole, of one or more of grey iron and aluminum.

The crankcase portion 102 houses a crankshaft, and is configured for variation in the displacement of the engine assembly 100. For example and in one specific implementation, the engine assembly 100 may have an initial displacement of 3.9 L based on the quantity and diameter of the plurality of cylinders 103 and the stroke length permitted by the crankcase portion 102 for pistons, piston rods, and connecting rods coupled to the crankshaft housed in the crankcase portion. In order to reduce the 3.9 L displacement, a top surface of the crankcase portion 102 (i.e., configured to serve as a mating surface of the crankcase portion 102, to engage the combined cylinder head and cylinder block portion 101) may be machined, for example removing a 5 mm layer of the crankcase portion 102. In one implementation, removing the 5 mm layer of the crankcase portion 102 effectively raises a crankshaft disposed within by a corresponding 5 mm towards the combined cylinder head and cylinder block portion 101, thereby reducing displacement across all cylinders 103.

In one implementation, the top surface of the crankcase portion 102 may include a 5 mm crankcase extension casted into the crankcase during manufacture. The crankcase extension permits optional machining of the top layer such that the machined crankcase is configured to matingly engage a cylinder block portion bottom surface 104 of the combined cylinder head and cylinder block portion 101. Alternatively, in the same manner, an unmachined crankcase can engage the cylinder block portion bottom surface 104. In other words, the crankcase extension may be removed in varying degrees (e.g., where the crankcase extension is 5 mm high, by any height ranging from 0 mm to 5 mm, depending on a desired displacement reduction) and then engaged to the combined cylinder head and cylinder block portion 101.

A machined crankcase may be fitted with a new crankshaft or crankshaft assembly to accommodate a shorter stroke length caused by the removal of the crankcase extension. For example, the dimensions of a crankshaft configured to operate with a full crankcase extension (i.e., where none of the crankcase extension is removed) may conflict with an engine assembly with the crankcase extension removed. In some arrangements, a crankshaft may be selected to further reduce the stroke volume within the cylinders 103, thereby reducing the displacement further. For example, a first crankshaft having a larger first rotational circumference can in operation cause associated rods and pistons to travel along a longer stroke distance. In turn, a replacement second crankshaft having a smaller rotational circumference can in operation cause associated rods and pistons to travel along a shorter stroke distance. As such, in addition to machining the crankcase extension, the crankshaft may be replaced with one having a smaller rotational diameter to effectively reduce the displacement of an engine assembly.

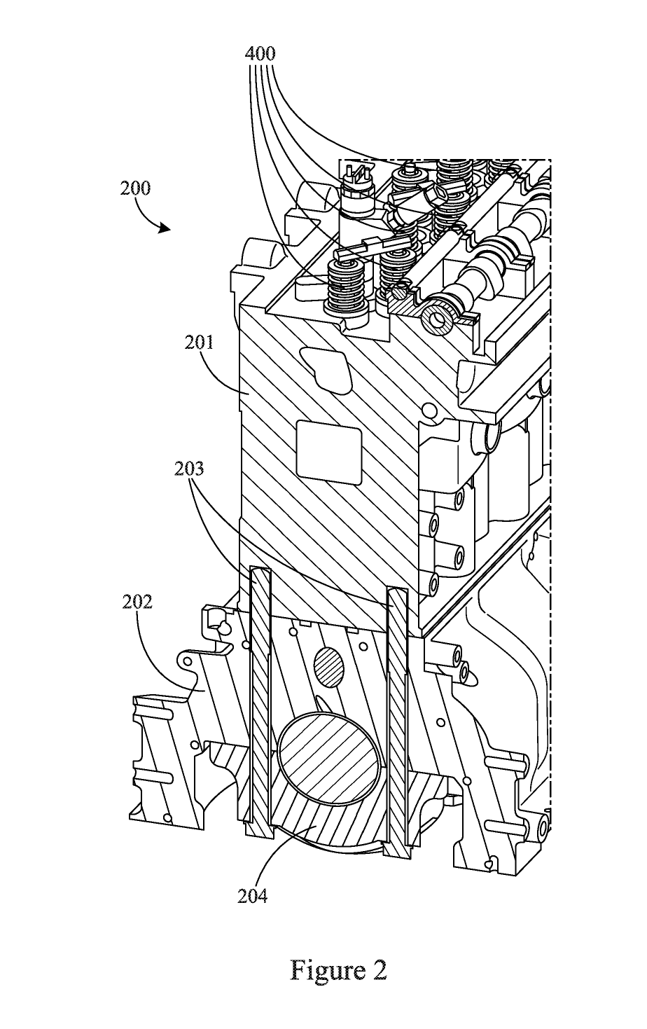

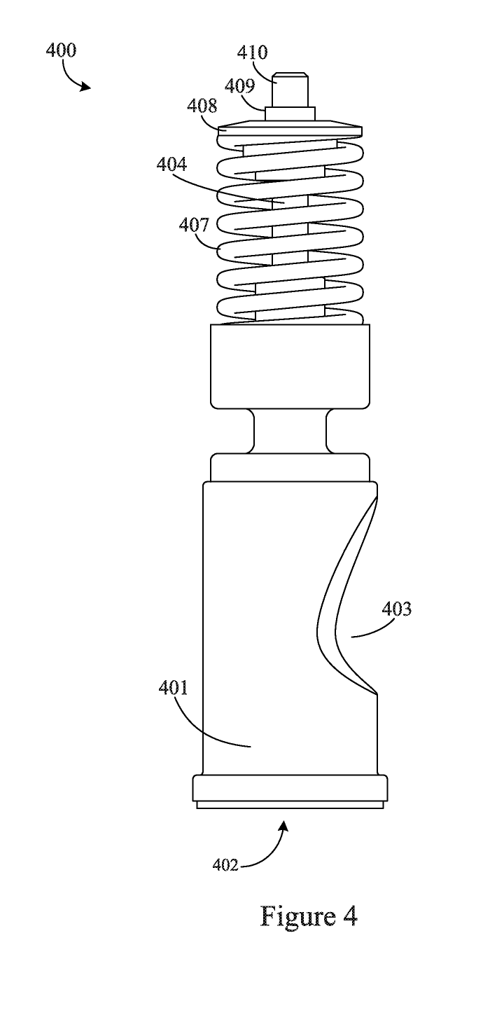

FIG. 2 is a side cross-sectional view of an engine assembly 200 configured for varied engine displacement, in accordance with example embodiments. The engine assembly 200 includes a combined cylinder head and cylinder block portion 201 and a crankcase portion 202 (e.g., similar to the combined cylinder head and cylinder block portion 101 and the crankcase portion 102 of FIG. 1, respectively). The crankcase portion 202 is coupled to the combined cylinder head and cylinder block portion 201 via a plurality of bolts 203. The crankcase portion 202 includes a crankshaft 204 fitted within. The engine assembly 200 may include a gasket or seal positioned between respective mating surfaces of the crankcase portion 202 and the combined cylinder head and cylinder block portion 201. The combined cylinder head and cylinder block portion 201 houses a plurality of valve cartridge assemblies 400 (illustrated in further detail in FIGS. 4-6) in the cylinder head portion of the combined cylinder head and cylinder block portion 201. The valve cartridge assemblies include the plurality of intake and exhaust valves discussed above.

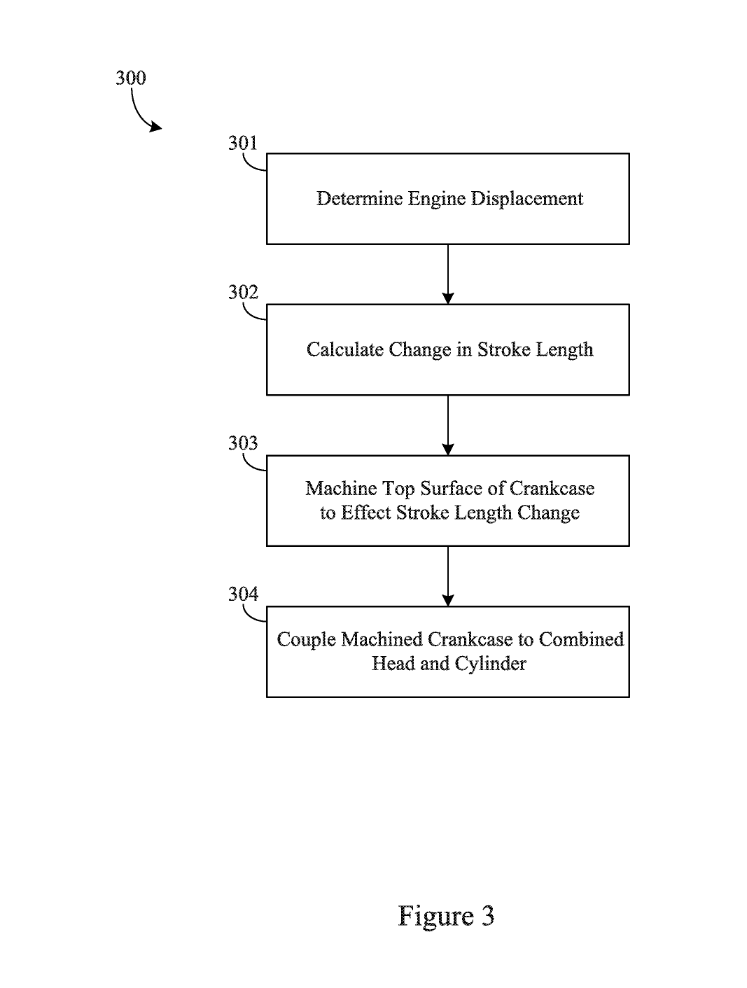

FIG. 3 is a flow diagram showing a method 300 of varying the displacement of an engine, in accordance with example embodiments. In process 301, a base displacement of the engine is determined. The base displacement is determined as a function of the quantity of cylinders in the engine, the diameter of each of the quantity of cylinders, and a stroke distance provided by a crankshaft and associated rods and pistons within each of the quantity of cylinders. In process 302, a change in a stroke length is calculated. The change in the stroke length depends on a requested volumetric change in the engine displacement, in view of constant cylinder diameters and a constant quantity of cylinders in the engine. Once the change in the stroke length is calculated based on the change in engine displacement and the diameter and quantity of cylinders in the engine, a top surface (i.e., a mating surface) of a crankcase of the engine is machined to remove a height of crankcase material sufficient to accommodate the calculated change in the stroke length in process 303. Removing the height of crankcase material from the mating surface effectively allows an associated crankshaft to be disposed closer to the block and cylinder head portions of the engine, thereby decreasing the stroke length of each cylinder. In process 304, the machined crankcase is coupled to a combined cylinder head and cylinder block portion of the engine, for example through the use of bolts. The machined crankcase may require a new crankshaft or crankshaft assembly (i.e., relative to a crankshaft fitted for the crankcase portion prior to machining) in accordance with particular embodiments. The new crankshaft accommodating the change in stroke and the corresponding change in the engine displacement is coupled to the machined crankcase.

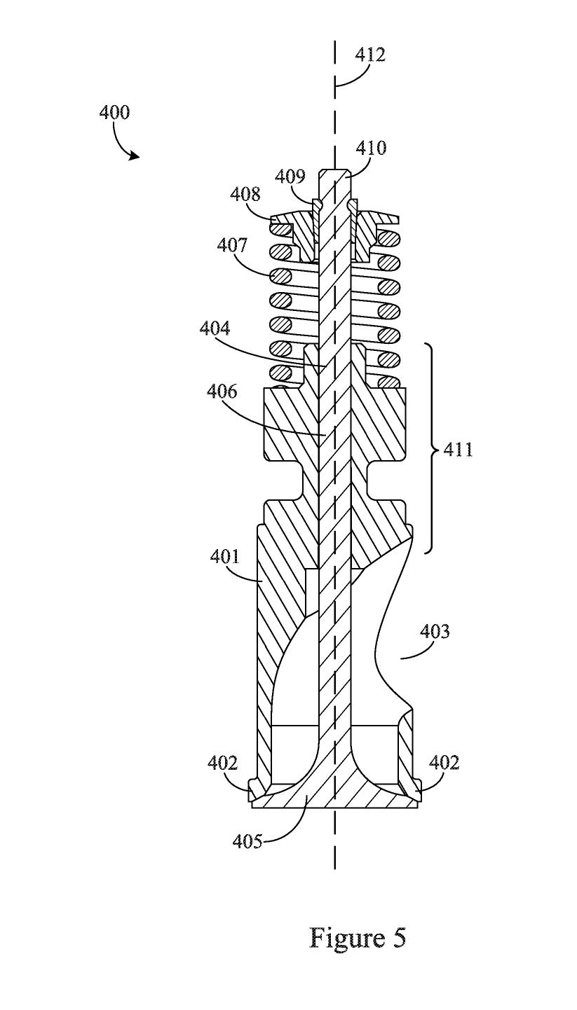

FIG. 4 is a side view of a valve cartridge assembly 400, in accordance with example embodiments. As shown in FIG. 2, the valve cartridge assembly 400 houses at least one valve and is configured to be disposed in a cylinder head portion of an engine. FIG. 5 is a side cross-sectional view of the cartridge assembly 400 of FIG. 4. A valve cartridge assembly 400 includes a cartridge housing 401 having a valve seat defining a valve seat opening 402 and an intake/exhaust port opening 403. The cartridge housing 401 houses a valve 404 movably positioned in the cartridge housing 401. The valve 404 includes a proximal end 410 disposed at one end of a valve stem 406 and a valve head 405 disposed at a corresponding other end of the valve stem 406.

The valve cartridge assembly 400 includes a valve spring 407 coupled to the valve stem 406 of the valve 404. In particular embodiments, the valve spring 407 is coupled to the valve stem 406 via a spring retainer 408 and a valve collate 409 at the proximal end 410. The spring retainer 408 and the valve collate 409 retain the valve spring 407 between the valve stem 406 and the cartridge housing 401 through which the valve stem 406 extends. In some embodiments, at least one of the spring retainer 408, the valve collate 409, and the cartridge housing 401 is configured to restrict the lateral movement of the valve 404 (i.e., such that the valve 404 is substantially restricted to two-directional movement). For example, the cartridge housing 401 may include a guide channel 411, which is an aperture along a center axis 412 in the cartridge housing 401, extending from the intake/exhaust port opening 403 up and through the proximal end (i.e., towards the proximal end 410) of the cartridge housing 401. The guide channel 411 is just large enough in diameter to accommodate the diameter and a length of the valve stem 406, disposed therein. As such, the valve 404 may translate up and down along the center axis of the cartridge housing 401 in the guide channel 411, but may not appreciably translate radially or laterally from the center axis.

In some arrangements, the valve cartridge assembly 400 includes a plurality of valves 404. For example, a single cartridge housing 401 can include a corresponding one intake/exhaust port opening 403, one valve seat opening 402, one guide channel 411, and so on, for each of a plurality of valves 404. As such, a given valve cartridge assembly 400 can be a single unit comprising a plurality of intake and/or exhaust valves.

In operation, the valve 404 is movable within the cartridge housing 401 from a seated position (closed) wherein the valve head 405 is positioned on the valve seat to an unseated position (open) wherein the valve head 405 extends out of the valve seat opening 402 (i.e., away from the cartridge housing 401). In the seated positioned, the valve head 405 is positioned in the valve seat to prevent fluid communication between the valve seat opening 402 and the intake/exhaust port opening 403. In the unseated position, the valve stem 406 of the valve 404 extends into the valve seat opening 402, thereby lifting the valve head off the valve seat and permitting fluid communication between the intake/exhaust port opening 403 and the valve seat opening 402.

To open the valve cartridge assembly 400 (i.e., to transition the valve 404 from the seated position to the unseated position), an actuator such as a cam on an intake or exhaust camshaft applies force against the proximal end 410 of the valve stem 406. The force moves the proximal end 410 of the valve stem 406 with respect to the cartridge housing 401 and thereby compresses the valve spring 407. As the proximal end 410 of the valve stem 406 is moved closer to the cartridge housing 401, the valve cartridge assembly 400 is opened as the valve head 405 is unseated from the valve seat at the valve seat opening 402. When the valve cartridge assembly 400 is opened it allows intake air to flow through the cartridge housing 401 and into a combustion chamber of an engine cylinder of an engine housing the valve cartridge assembly or permits exhaust air to flow through the cartridge housing 401 from the engine cylinder. When the actuation force applied by the cam is removed, a biasing force from the compressed valve spring 407 pushes the valve 404 back into the seated configuration closing the valve cartridge assembly 400 as the valve head 405 is re-seated in the valve seat opening 402.

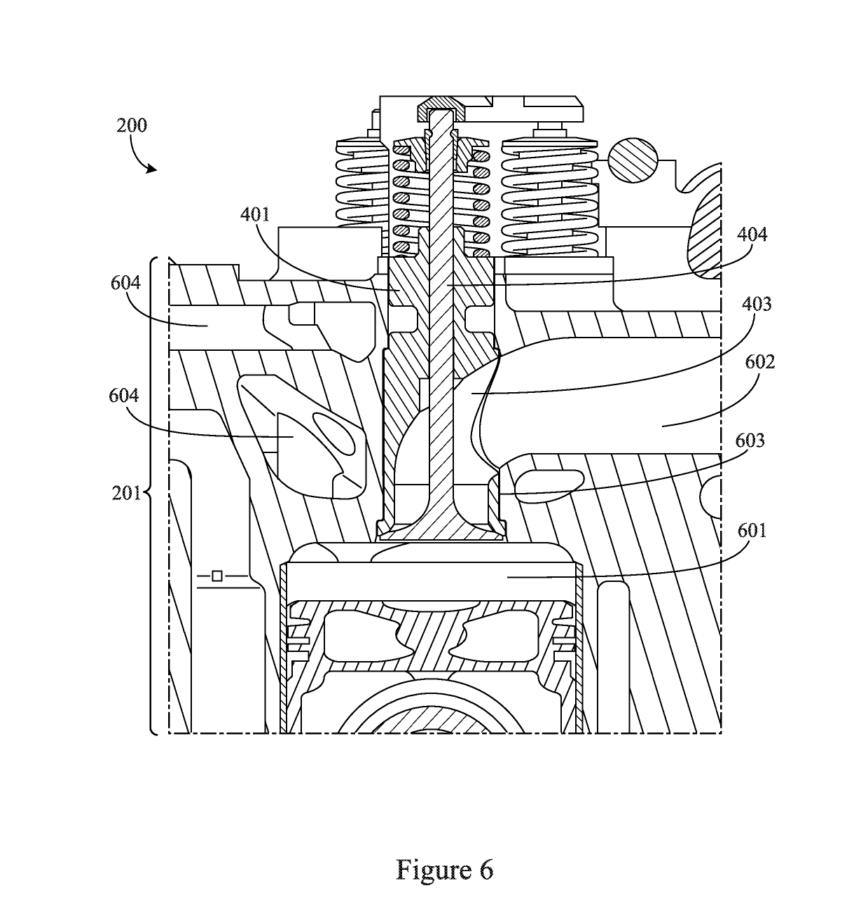

FIG. 6 is a cross-sectional view of an engine assembly 200 including the valve cartridge assembly 400 of FIG. 4, in accordance with example embodiments. The engine assembly 200 houses the valve cartridge assembly 400 in the cylinder head portion of the combined cylinder head and cylinder block portion 201 of the engine assembly 200. The valve cartridge assembly 400 is inserted into a cartridge slot 603 disposed at the cylinder head portion of the combined cylinder head and cylinder block portion 201. The valve cartridge assembly 400 can be inserted into the cartridge slot 603 via a corresponding cylinder 601. Once inserted into the cartridge slot 603, the valve cartridge assembly 400 fluidly couples the intake/exhaust port opening 403 to an intake/exhaust port channel 602. In some arrangements, the cartridge slot 603 is an aperture extending from the cylinder 601 and through the cylinder head portion of the combined cylinder head and cylinder block portion 201. As such, upon inserting the valve cartridge assembly 400 into the cartridge slot, a proximal end of the valve cartridge assembly 400 (e.g., containing at least a part of the valve 404 and the valve spring 407) may externally protrude from the cylinder head portion. An actuator (e.g., a cam on a corresponding camshaft) may then selectively apply a force on the proximal end of the cartridge assembly 400 to open and close the valve 404.

In FIG. 6, the engine assembly 200 further includes a plurality of water jackets 604. The plurality of water jackets 604 are fluid conduits disposed through the cylinder head portion of the combined cylinder head and cylinder block portion 201, and are associated with a pressure source (e.g., a water pump) and a fluid source (e.g., a coolant reservoir). The pressure source causes coolant in the fluid source to travel through the plurality of water jackets 604. The coolant exchanges heat with materials and components adjacent to the plurality of water jackets 604 as the coolant travels. The plurality of water jackets 604 may be disposed adjacent to the cartridge slot 603. As such, heat from an exhaust gas flow from the cylinder 601, into the valve cartridge assembly 400 in an open configuration, and out through the intake/exhaust port channel 602 may be transferred to coolant in the adjacent plurality of water jackets 604.

For the purpose of this disclosure, the term “coupled” means the joining of two members directly or indirectly to one another. Such joining may be stationary or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

It should be noted that the orientation of various elements may differ according to other exemplary embodiments, and that such variations are intended to be encompassed by the present disclosure. It is recognized that features of the disclosed embodiments can be incorporated into other disclosed embodiments.

It is important to note that the constructions and arrangements of apparatuses or the components thereof as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter disclosed. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

While various inventive embodiments have been described and illustrated herein, those of ordinary skill in the art will readily envision a variety of other mechanisms and/or structures for performing the function and/or obtaining the results and/or one or more of the advantages described herein, and each of such variations and/or modifications is deemed to be within the scope of the inventive embodiments described herein. More generally, those skilled in the art will readily appreciate that, unless otherwise noted, any parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, the technology described herein may be embodied as a method, of which at least one example has been provided. The acts performed as part of the method may be ordered in any suitable way unless otherwise specifically noted. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

In the claims, as well as in the specification above, all transitional phrases such as “comprising,” “including,” “having,” “involving,” and the like are to be understood to be open-ended, i.e., to mean including but not limited to.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A method of varying a displacement of an engine comprising:
determining a change in a stroke distance within each of a quantity of cylinders, the change in the stroke distance of the engine required to obtain a pre-determined volumetric change in a displacement of the engine;
machining a top surface of a crankcase so as to remove a height of material from the crankcase, the height of material calculated to correspond to the change in the stroke distance of the engine required to obtain the volumetric change in the displacement of the engine; and
coupling the top surface of the crankcase to a mating surface of an engine block portion of the engine.

2. The method of claim 1, wherein the engine block portion is integrally formed with a cylinder head portion.

3. The method of claim 2, further comprising installing a crankshaft in the crankcase, the crankshaft being selected to accommodate the height of material removed.

3. The method of claim 3, wherein the crankshaft is selected to decrease the stroke distance.

4. The method of claim 2, further comprising coupling a valve cartridge assembly to the cylinder head portion of the engine block portion at a cartridge slot, the valve cartridge assembly comprising:
a cartridge housing including a port and a valve seat defining a valve seat opening;
a valve coupled to the cartridge housing and positioned, in part in the cartridge housing, the valve including a valve stem and a valve head, the valve head positioned in the valve seat of the cartridge housing in a closed configuration and the valve head extending out of the valve seat opening in an open configuration; and
a valve spring coupled to the cartridge housing and the valve stem, biasing the valve towards the closed configuration.

5. The method of claim 5, wherein coupling the valve cartridge assembly to the cylinder head portion includes inserting the valve cartridge assembly through one of the quantity of cylinders in the engine block portion and into the cartridge slot at the cylinder head portion.

6. The method of claim 5, further comprising forming the cylinder head portion to include at least one water jacket adjacent to each of a plurality of cartridge slots, wherein a valve cartridge assembly is coupled to each of the plurality of cartridge slots.

7. The method of claim 5, wherein the cartridge housing includes a plurality of valves, and corresponding pluralities of each of the valve seat, the valve seat opening, and the valve spring.

8. The method of claim 1, further comprising determining a base displacement of the engine based on the quantity of cylinders disposed in the engine, a diameter of each of the quantity of cylinders, and the stroke distance within each of the quantity of cylinders, wherein the change in the stroke distance is based on the base displacement.

9. A valve cartridge assembly for use in varying a displacement of an engine comprising:
a cartridge housing including a port and a valve seat defining a valve seat opening;
a valve coupled to the cartridge housing and positioned partially within the cartridge housing, the valve including a valve stem and a valve head, the valve head positioned in the valve seat in a closed configuration and the valve head extending out of the valve seat opening in an open configuration; and
a valve spring coupled to the cartridge housing and the valve stem of the valve, biasing the valve towards the closed configuration.

10. The valve cartridge assembly of claim 10, further comprising a spring retainer coupling the valve spring to the valve stem.

11. The valve cartridge assembly of claim 10, wherein the cartridge housing fluidly couples the valve seat opening to the port.

12. The valve cartridge assembly of claim 10, wherein the cartridge housing further includes a guide channel, the guide channel accommodating the valve stem and restricting the valve to a two-directional movement.

13. The valve cartridge assembly of claim 10, wherein the cartridge housing includes a plurality of valves, and corresponding pluralities of each of the valve seat, the valve seat opening, and the valve spring.

14. An engine assembly, comprising:
an engine including an engine block portion integrally formed with a cylinder head portion, the engine block portion including a plurality of cylindrical cylinder block openings and a first mating surface; and
a crankcase coupled to the engine block portion, the crankcase including a second mating surface comprising a crankcase extension, the crankcase extension configured for removal from the crankcase to change a displacement of the engine assembly.

15. The engine assembly of claim 15, further comprising a crankshaft installed in the crankcase, the crankshaft selected to accommodate a height of a removed portion of the crankcase extension.

16. The engine assembly of claim 16, wherein the crankshaft is selected so as to decrease the displacement of the engine assembly.

17. The engine assembly of claim 15, further comprising a valve cartridge assembly coupled to the cylinder head portion, the valve cartridge assembly including:
a cartridge housing including a port and a valve seat defining a valve seat opening;
a valve disposed within the cartridge housing, the valve including a valve stem and a valve head, the valve head positioned in the valve seat in a closed configuration and the valve head extending out of the valve seat opening in an open configuration; and
a valve spring coupled to the cartridge housing and the valve stem, biasing the valve towards the closed configuration.

18. The engine assembly of claim 18, wherein the cartridge housing fluidly couples the valve seat opening to the port.

19. The engine assembly of claim 18, wherein the cartridge housing further includes a guide channel, the guide channel accommodating the valve stem and restricting the valve to a two-directional movement.

20. The engine assembly of claim 18, wherein the cartridge housing includes a plurality of valves, and corresponding pluralities of each of the valve seat, the valve seat opening, and the valve spring.
